(19) United States
(12) Patent Application Publication
(10) Pub. No.: US 2016/0222796 A1
(43) Pub. Date: Aug. 4, 2016

(54) MANUFACTURING METHOD FOR A BAFFLE-CONTAINING BLADE

(71) Applicant: UNITED TECHNOLOGIES CORPORATION, Hartford, CT (US)

(72) Inventors: Brandon W. Spangler, Vernon, CT (US); Edwin Otero, Southington, CT (US)

(73) Assignee: United Technologies Corporation, Hartford, CT (US)

(21) Appl. No.: 15/022,640

(22) PCT Filed: Sep. 16, 2014
(86) PCT No.: PCT/US2014/055765

§ 371 Date: Mar. 17, 2016

Related U.S. Application Data
(60) Provisional application No. 61/879,454, filed on Sep. 18, 2013.

(51) Int. Cl. F01D 5/18; F01D 5/14

(52) U.S. Cl. CPC F01D 5/187; F01D 5/147; F05D 2220/32; F05D 2230/31; F05D 2240/81; F05D 2260/202

(57) ABSTRACT

A blade includes a platform and a monolithic airfoil extending from the platform to a tip. The airfoil includes a first wall extending from a leading edge to a trailing edge, a second wall extending from the leading edge to the trailing edge and joined to the first wall at the leading edge, and at least one rib extending from the first wall to the second wall. The at least one rib and the first and second walls define a cavity. The blade also includes a baffle positioned within the cavity. The baffle has walls that are separate and distinct from and not attached to the at least one rib and the first and second walls of the airfoil. A method for forming a blade includes forming a platform and forming an airfoil and a baffle within the airfoil on a layer-by-layer basis using additive manufacturing.

### BACKGROUND

Dual wall airfoils have the potential to offer improved cooling to blades used in gas turbine engines. Turbine blades in particular are exposed to extremely high temperature during engine operation. Dual wall airfoils have sets of outer walls and sets of inner walls. The outer walls and the inner walls are separated by “skin cavities” and the inner walls are separated from one another by a central cavity. Cooling fluid flows through the skin cavities and the central cavity to provide impingement cooling to the inner and outer walls and/or form a cooling film along the outer surface of the outer walls.

### SUMMARY

A blade includes a platform and a monolithic airfoil extending from the platform to a tip. The airfoil includes a first wall extending from a leading edge to a trailing edge, a second wall extending from the leading edge to the trailing edge and joined to the first wall at the leading edge, and at least one rib extending from the first wall to the second wall. The at least one rib and the first and second walls define a cavity. The blade also includes a baffle positioned within the cavity. The baffle has walls that are separate and distinct from and not attached to the at least one rib and the first and second walls of the airfoil.

A method for forming a blade includes forming a platform and forming an airfoil on a layer-by-layer basis using additive manufacturing. The airfoil includes a first wall that extends radially from the platform to a blade tip and extends axially from a leading edge to a trailing edge, a second wall that extends radially from the platform to the blade tip and extends axially from the leading edge to the trailing edge, and at least one rib that extends from the first wall to the second wall. The first wall and the second wall are joined at the leading edge, and the at least one rib and the first and second walls define a cavity. The airfoil further includes forming a baffle within the cavity on a layer-by-layer basis using additive manufacturing. The baffle has walls that are separate and distinct from the at least one rib and the first and second walls.

### BRIEF DESCRIPTION OF THE DRAWINGS

FIG. 1 is a side view of a blade.

FIG. 2A is a cross section view of one embodiment of a blade containing a baffle taken along the line A-A shown in FIG. 1.

FIG. 2B is a cross section view of one embodiment of a blade containing a baffle taken along the line B-B shown in FIG. 1.

FIG. 3A is a cross section view of another embodiment of a blade containing a baffle taken along the line A-A shown in FIG. 1.

FIG. 3B is a cross section view of another embodiment of a blade containing a baffle taken along the line B-B shown in FIG. 1.

### DETAILED DESCRIPTION

The present invention provides a baffle-containing blade and a method of manufacturing such a blade using additive manufacturing. The baffle acts as a substitute for the inner walls within the blade airfoil by separating skin cavities from the central cavities. However, because the baffle is a separate element and is not attached to the outer wall, the stresses caused by connected inner and outer walls are eliminated. Additionally, the baffle dampens vibrations within the blade, removing or reducing the need for additional damping features.

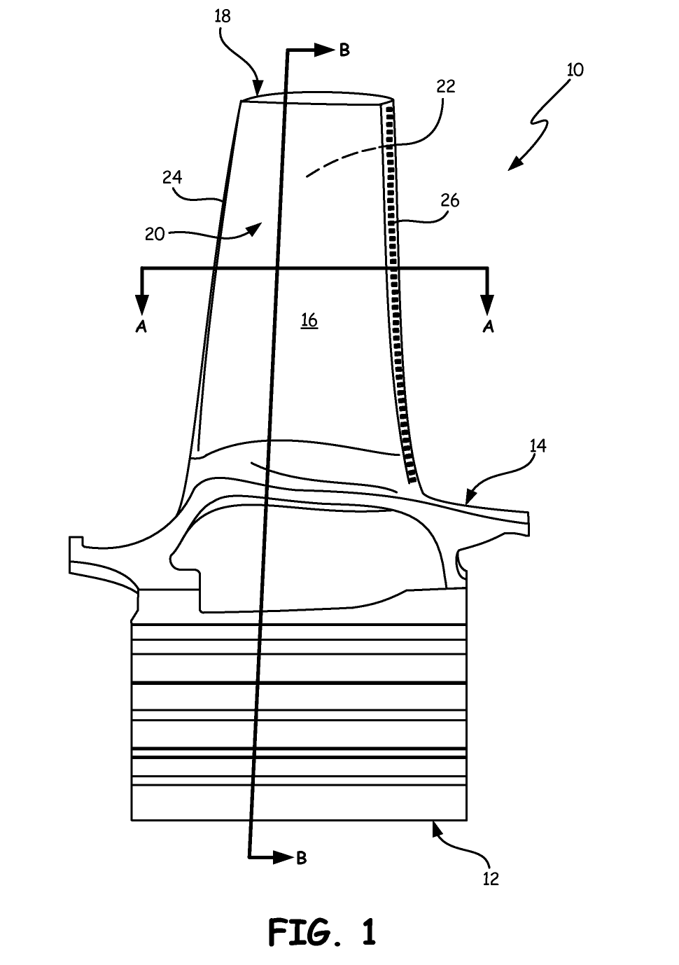

FIG. 1 is a side view of a blade. Blade 10 includes root section 12, platform 14, airfoil 16 and tip section 18. Blade 10 extends from root section 12 to tip section 18 along a radial axis. Airfoil 16 extends radially from platform 14. Airfoil 16 includes pressure side wall 20 and suction side wall 22. Pressure side wall 20 and suction side wall 22 are joined at leading edge 24 and each extends downstream from leading edge 24 to trailing edge 26. In some embodiments, airfoil 16 is monolithic. For the purposes of this patent application, a monolithic airfoil 16 is formed from a single piece of material (i.e. the airfoil is not composed of two or more separate pieces of material that are welded, brazed or otherwise connected together to form a single component).

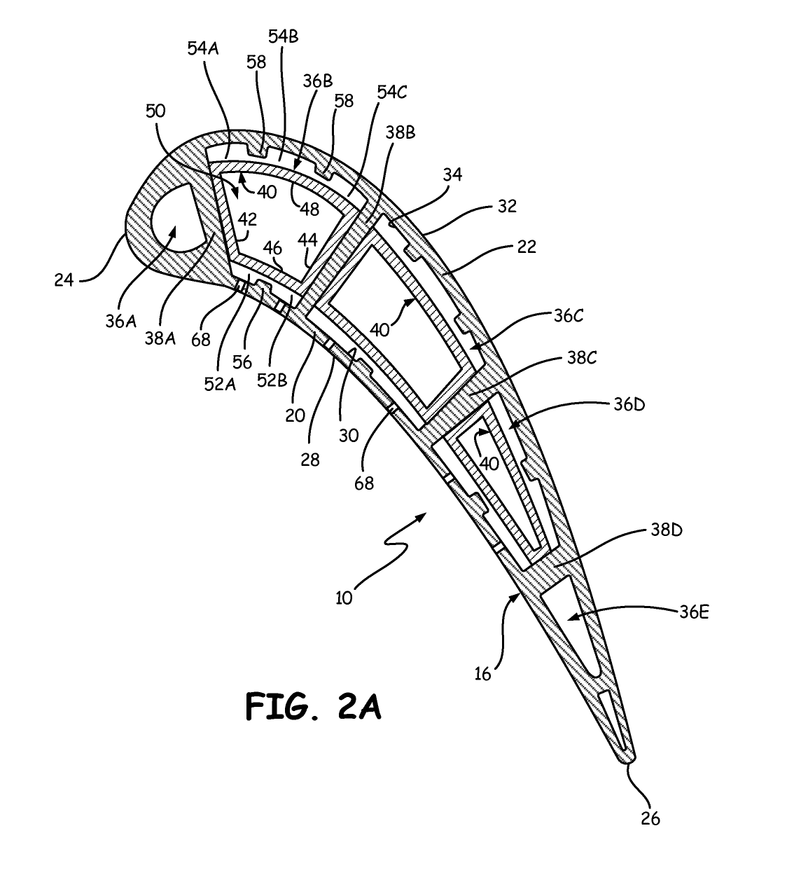

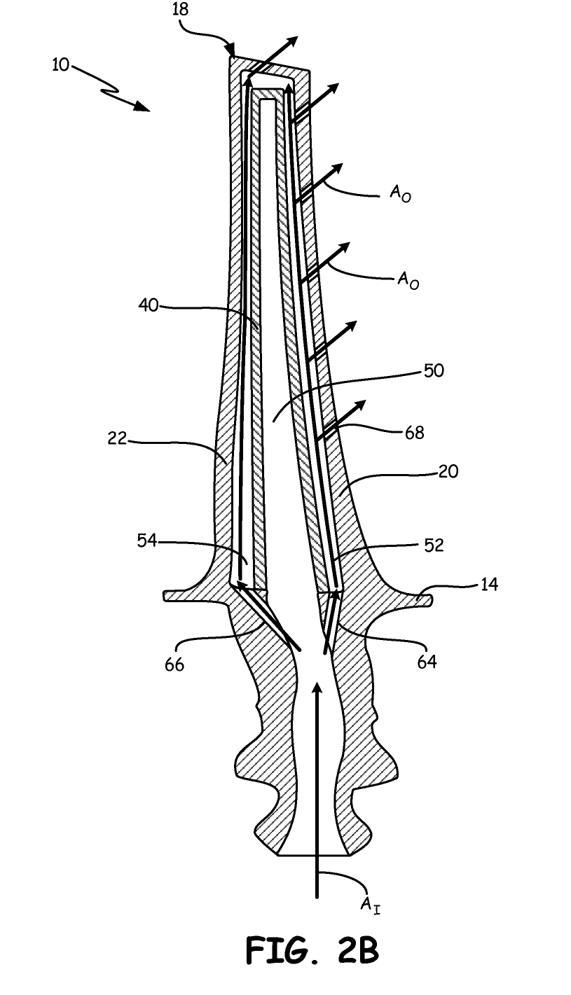

FIG. 2A illustrates a cross section view of one embodiment of baffle-containing blade 10 taken along the line A-A shown in FIG. 1. Pressure side wall 20 forms a first outer wall, and suction side wall 22 forms a second outer wall, the two walls meeting at leading edge 24. Pressure side wall 20 includes outer surface 28 and inner surface 30, and suction side wall 22 includes outer surface 32 and inner surface 34. One or more cavities 36 separate pressure side wall 20 and suction side wall 22. As shown in FIG. 2A, five cavities 36A-36E are present between pressure side wall 20 and suction side wall 22. Cavities 36 are separated from one another by ribs 38. Ribs 38A-38D extend from inner surface 30 of pressure side wall 20 to inner surface 34 of suction side wall 22. Each cavity 36 is defined by inner surface 30 of pressure side wall 20, inner surface 34 of suction side wall 22 and two ribs 38 (an upstream rib and a downstream rib). For example, according to the embodiment shown in FIG. 2A, cavity 36B is defined by inner surface 30, inner surface 34 and ribs 38A and 38B.

Baffles 40 are positioned within one or more cavities 36 of blade 10. Baffle 40 is an insert sized to fit within a cavity 36. Each baffle 40 includes upstream wall 42, downstream wall 44, pressure side baffle wall 46 and suction side baffle wall 48. Upstream wall 42, downstream wall 44, pressure side baffle wall 46 and suction side baffle wall 48 define central cavity 50 within baffle 40. As described below in greater detail, cooling fluid is delivered through central cavity 50 of baffle 40 to provide cooling to airfoil 16 and blade 10. In some embodiments, central cavity 50 of one baffle 40 is connected to central cavity 50 of another baffle 40 within blade 10 to form a serpentine cooling circuit.

The walls of baffle 40 are separate and distinct from and not attached to inner surface 30 of pressure side wall 20, inner surface 34 of suction side wall 22 and ribs 38 (i.e. the inner surfaces of airfoil 16). As shown in FIG. 2A, upstream wall 42 is positioned near upstream rib 38A and downstream wall 44 is positioned near downstream rib 38B. Pressure side baffle wall 46 has a shape complementary to pressure side wall 20 and is located proximate pressure side wall 20. Suction side baffle wall 48 has a shape complementary to suction side wall 22 and is located proximate suction side wall 22. While pressure side baffle wall 46 is located near pressure side wall 20, it is spaced from inner surface 30 of pressure side wall 20 to form cavity 52 therebetween. Similarly, while suction side baffle wall 48 is located near suction side wall 22, it is spaced from inner surface 34 of suction side wall 22 to form cavity 54 therebetween. Like central cavity 50, cooling fluid is delivered through cavities 52 and 54 of baffle 40 to provide cooling to airfoil 16 and blade 10. Cavities 52 and 54 are sometimes referred to as “skin cavities” as they are cavities located near the skin (outer wall) of the airfoil. In some embodiments, passages 68 are formed in pressure side wall 20 so that cooling fluid can flow from cavities 52 and form a cooling film along outer surface 28 of pressure side wall 20. Likewise, passages can be formed in suction side wall 22 so that cooling fluid can flow from cavities 54 and form a cooling film along outer surface 32 of suction side wall 22.

One or more standoffs or standoff ribs can be present within cavities 52 and 54 to prevent contact between pressure side baffle wall 46 and pressure side wall 20 and suction side baffle wall 48 and suction side wall 22, respectively. As shown in FIG. 2A, standoff rib 56 extends from inner surface 30 of pressure side wall 20 towards pressure side baffle wall 46 of baffle 40. In some embodiments, standoff rib 56 contacts pressure side baffle wall 46 at ambient temperature (approximately 25° C.). In other embodiments, standoff rib 56 approaches but does not contact pressure side baffle wall 46 at ambient temperature. In these embodiments, the distance between standoff rib 56 and pressure side baffle wall 46 is between about 0.001 inches (0.025 mm) and about 0.005 inches (0.13 mm) In some embodiments, standoff rib 56 is a longitudinal rib that spans substantially the entire length of inner surface 30 and/or baffle 40. In these embodiments, standoff rib 56 serves to separate cavity 52 into two substantially distinct subcavities (labeled 52A and 52B in FIG. 2A). In those embodiments in which standoff rib 56 contacts pressure side baffle wall 46, cavities 52A and 52B are separate and distinct. Where standoff rib 56 approaches but does not contact pressure side baffle wall 46, fluid flowing through cavities 52A and 52B is able to cross between cavities near pressure side baffle wall 46. In other embodiments, standoff rib 56 is a pedestal-type structure and does not separate cavity 52 into subcavities but can serve to increase turbulence of fluid flowing through cavity 52.

Standoff ribs 58 extend from inner surface 34 of suction side wall 22 towards suction side baffle wall 48 of baffle 40. Standoff ribs 58 are structured and function similarly to standoff rib 56. As shown in FIG. 2A, two standoff ribs 58 extend from inner surface 34 towards suction side baffle wall 48. In some embodiments, standoff ribs 58 contact suction side baffle wall 48 at ambient temperature. In other embodiments, standoff ribs 58 approach but do not contact suction side baffle wall 48 at ambient temperature. In these embodiments, the distance between standoff rib 56 and pressure side baffle wall 46 is between about 0.001 inches (0.025 mm) and about 0.005 inches (0.13 mm) In some embodiments, standoff ribs 58 are longitudinal ribs that span substantially the entire length of inner surface 34 and/or baffle 40. In these embodiments, standoff ribs 58 serve to separate cavity 54 into three substantially distinct subcavities (labeled 54A-54C in FIG. 2A). In other embodiments, standoff ribs 58 are pedestal-type structures and do not separate cavity 54 into subcavities.

FIG. 2B illustrates a cross section view of blade 10 taken along the line B-B shown in FIG. 1, showing pressure side wall 20, suction side wall 22, baffle 40 and cavities 50, 52 and 54. As shown in FIG. 2B, baffle extends from a region near platform 14 to a region near tip section 18. As shown by arrows A_{I}, cooling fluid enters cavity 36 from root section 12. Just before cooling fluid A_{I} reaches baffle 40 it passes through feed openings 64 and 66. Feed opening 64 communicates with cavity 52 and feed opening 66 communicates with cavity 54, allowing some of the cooling fluid to reach cavities 52 and 54 instead of entering central cavity 50 of baffle 40. In the embodiment shown in FIG. 2B, cooling fluid exits airfoil 16 through film passages 68 within pressure side wall 20 and tip section 18 as shown by arrows A_{O}. In some embodiments, cooling fluid A_{O} can also exit airfoil 16 through film passages 68 within suction side wall 22.

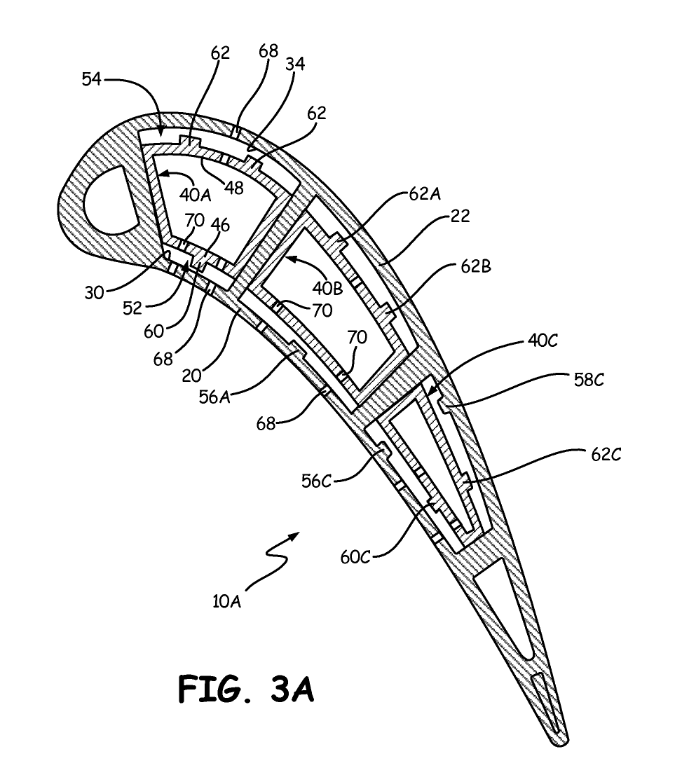

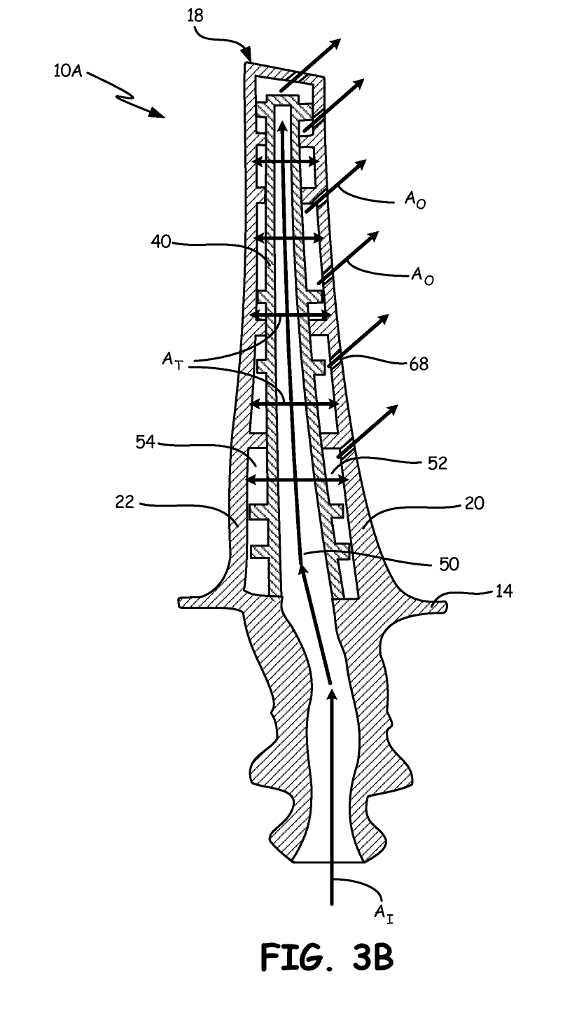

Standoff ribs can also extend from baffle 40 towards inner surface 30 of pressure side wall 20 and/or inner surface 34 of suction side wall 22. FIG. 3A illustrates a cross section view of another embodiment of baffle-containing blade 10A taken along the line A-A shown in FIG. 1. Blade 10A is similar to blade 10 but shows different standoff orientations. For example, with respect to baffle 40A, standoff rib 60 extends from pressure side baffle wall 46 towards pressure side wall 20. Similar to standoff rib 56, standoff rib 60 can contact inner surface 30 of pressure side wall 20 at ambient temperature or approach but not contact inner surface 30 at ambient temperature (i.e. 0.001 inches to 0.005 inches). Standoff rib 60 can be a longitudinal rib that spans substantially the entire length of baffle 40. In these embodiments, standoff rib 60 can separate cavity 52 into two substantially distinct subcavities. Alternatively, standoff rib 60 can be a pedestal-type structure that does not separate cavity 52 into subcavities but can serve to increase turbulence of fluid flowing through cavity 52. Standoff ribs 62 extend from suction side baffle wall 48 towards suction side wall 22. Similar to standoff rib 58, standoff ribs 62 can contact inner surface 34 of suction side wall 22 at ambient temperature or approach but not contact inner surface 34 at ambient temperature. Standoff ribs 62 can be longitudinal ribs that span substantially the entire length of baffle 40 or pedestal-type structures.

FIG. 3A also shows other possible standoff/baffle configurations. With respect to baffle 40B, standoff rib 56A extends from inner surface 30 of pressure side wall towards baffle 40B while standoff ribs 62A and 62B extend from suction side baffle wall 48 towards suction side wall 22. With respect to baffle 40C, standoff rib 56C extends from inner surface 30 of pressure side wall towards baffle 40C, standoff rib 58C extends from inner surface 30 of pressure side wall towards baffle 40C, standoff rib 60C extends from pressure side baffle wall 46 towards pressure side wall 20, and standoff rib 62C extends from suction side baffle wall 48 towards suction side wall 22.

FIG. 3A also illustrates impingement passages 70 within the walls of baffles 40A-40C. Impingement passages 70 allow cooling fluid to flow from central cavity 50 through the walls of baffle 40 and into skin cavities 52 and 54 to provide additional cooling to pressure side wall 20 and suction side wall 22. FIG. 3B illustrates a cross section view of blade 10A taken along the line B-B shown in FIG. 1, showing cooling fluid (arrows A_{T}) crossing the walls of baffle 40 to flow from cavity 50 within baffle 40 to cavities 52 and 54 outside baffle 40.

The design of blade 10 with baffle 40 described herein offers high durability and protection from harmful vibratory responses. For example, airfoil 16 and baffle 40 are separate and distinct pieces of material that are not connected to one another. As airfoil 16 heats up (e.g., during takeoff where fuel bum is high), pressure side wall 20 and suction side wall 22 are exposed to extremely high temperatures. Baffle 40 is comparatively cooler because it is insulated from the hot gas path by pressure side wall 20, suction side wall 22 and cooling fluid within cavities 50, 52 and 54. As the temperatures of pressure side wall 20 and suction side wall 22 increase, pressure side wall 20 and suction side wall 22 expand radially (from root to tip) and axially (away from each other). Because baffle 40 is comparatively cooler than pressure side wall 20 and suction side wall 22, baffle 40 does not expand to the same degree. Since airfoil 16 and baffle 40 are separate and distinct pieces of material that are not connected to one another, pressure side wall 20 and suction side wall 22 are free to expand as their temperatures increase without causing strain or fatigue relative to baffle 40. As airfoil 16 cools, the opposite effect is observed with pressure side wall 20 and suction side wall 22 shrinking or compressing. As airfoil 16 and baffle 40 are separate and distinct and not connected to one another, pressure side wall 20 and suction side wall 22 are free to shrink or compress as their temperatures decrease without causing strain or fatigue relative to baffle 40.

Baffle 40 also provides a damping effect to blade 10. Blade vibration is generally not desired during operation. Various components in a gas turbine engine vibrate at different responses. A component's mass, stiffness and temperature determine at what response (frequency) vibrations will occur. Because pressure side wall 20 and suction side wall 22 have different mass, stiffness and temperature than baffle 40 during operation, pressure side wall 20 and suction side wall 22 vibrate at a different response than baffle 40. When airfoil 16 of blade 10 vibrates, airfoil 16 rubs against baffle 40, which vibrates at a different response. Depending on the embodiment, pressure side wall 20 and suction side wall 22 rub against standoff ribs 60 and/or 62 and/or baffle 40 rubs against standoff ribs 56 and 58 on pressure side wall 20 and suction side wall 22, respectively. The contact or rubbing between baffle 40 and airfoil 16 provides a damping effect to airfoil 16, reducing its vibratory response.

Manufacturing blade 10 with baffle 40 is difficult. Due to the curvature of airfoil 16, baffle 40 cannot merely be inserted within blade 10 from root section 12 or from tip section 18. In order to insert baffle 40 within blade 10, blade 10 must be manufactured as two or more separate pieces that fit around baffle 40. These pieces of blade 10 are positioned around baffle 40 and welded or brazed together to form blade 10 around baffle 40. Monolithic blades 10 cannot be formed in this way. In order to form a monolithic blade 10, other techniques must be used. In one embodiment of the present invention, additive manufacturing is used to form blade 10 and baffle 40.

Forming blade 10 using additive manufacturing removes the need to split blade 10 into separate pieces and assemble it around baffle 40. Pressure side wall 20, suction side wall 22, ribs 38, baffles 40 and standoff ribs 56, 58, 60 and/or 62 of blade 10 are formed using additive manufacturing. In additive manufacturing, a three-dimensional computer model of blade 10 is formed and “sliced” into layers. Material is then added layer by layer to form blade 10. In some embodiments, blade 10 is formed starting at root section 12 or platform 14 and built layer by layer to tip section 18. When present in baffle 40, impingement passages 70 can also be formed during the additive manufacturing process. Film passages 68 in pressure side wall 20 and/or suction side wall 22 can also be formed during the additive manufacturing process or drilled following additive manufacturing.

Various additive manufacturing techniques can be used to form walls 20 and 22, ribs 38, baffles 40 and standoff ribs 56, 58, 60 and/or 62. In one embodiment, direct metal laser sintering is the additive manufacturing technique used to form the walls, ribs and baffles of blade 10. Direct metal laser sintering is an additive metal fabrication process often used with metal alloys. A layer of metal powder is positioned on a substrate or preceding metal layer according to the three-dimensional computer model of the part. A high-powered laser is then used to locally melt the layer of metal powder. This process of adding a layer of metal powder and locally melting the layer is repeated until the part is complete. In another embodiment, electron beam melting is the additive manufacturing technique used to form the walls and ribs of blade 10. Electron beam melting is similar to direct metal laser sintering, but possesses some differences. Electron beam melting is often used with titanium alloys and instead of melting the material with a laser, an electron beam in a high vacuum is used to melt each metal powder layer.

Walls 20 and 22 and ribs 38 can be formed of the same material as baffles 40 or of a different material. Manufacturing walls 20 and 22, ribs 38 and baffles 40 with the same material simplifies the manufacturing process. In one embodiment, walls 20 and 22, ribs 38 and baffles 40 are formed of a directionally solidified material. Directionally solidified materials possess grains that have been grown in a particular direction. The grain boundaries (defects in the crystal or crystallite structure) of directionally solidified materials extend predominantly in a single direction. Suitable directionally solidified materials include, but are not limited to, nickel, cobalt and titanium. In another embodiment, walls 20 and 22, ribs 38 and baffles 40 are formed of an equiaxed material. For equiaxed materials, the grains or crystals that make up the material have roughly the same properties in all directions (e.g., axes of approximately the same length). The grain boundaries of equiaxed materials can extend in multiple directions. Suitable equiaxed materials include, but are not limited to, nickel, cobalt and titanium.

Additive manufacturing allows the manufacture of a blade containing a baffle. The baffle provides the blade airfoil with a central cavity within the baffle and skin cavities between the baffle and the pressure and suction side walls. The baffle forms a dual wall component that can take advantage of improved cooling capabilities. The baffle also provides a damping effect to the blade. Additionally, the presence of baffles within the airfoil cavities does not increase the stress on the blade due to thermal expansion and shrinkage.

### DISCUSSION OF POSSIBLE EMBODIMENTS

The following are non-exclusive descriptions of possible embodiments of the present invention.

A blade can include a platform and a monolithic airfoil extending from the platform to a tip. The airfoil can include a first wall extending from a leading edge to a trailing edge, a second wall extending from the leading edge to the trailing edge and joined to the first wall at the leading edge, and at least one rib extending from the first wall to the second wall where the at least one rib and the first and second walls define a cavity. The blade can further include a baffle positioned within the cavity, the baffle having walls that are all separate and distinct from and not attached to the at least one rib and the first and second walls of the airfoil.

The blade of the preceding paragraph can optionally include, additionally and/or alternatively, any one or more of the following features, configurations and/or additional components:

A further embodiment of the foregoing blade can further include at least one standoff rib positioned between the baffle walls and the first wall where the standoff rib dampens vibration within the blade.

A further embodiment of any of the foregoing blades can further include that the at least one standoff rib is attached to only one of the first wall and the baffle.

A further embodiment of any of the foregoing blades can further include that the first wall has a first standoff rib that extends from the first wall towards the baffle, and the second wall has a second standoff rib that extends from the second wall towards the baffle.

A further embodiment of any of the foregoing blades can further include that the baffle has a third standoff rib that extends from the baffle towards the first wall or the second wall.

A further embodiment of any of the foregoing blades can further include that the baffle has a standoff rib that extends from the baffle towards the first wall or the second wall.

A further embodiment of any of the foregoing blades can further include that the platform has at least one feed opening that allows cooling air to pass through the platform and flow between the baffle and at least one of the first and second walls.

A further embodiment of any of the foregoing blades can further include that at least one impingement passage is formed in a baffle wall.

A further embodiment of any of the foregoing blades can further include that at least one film passage is formed in one of the first and second walls.

A further embodiment of any of the foregoing blades can further include that the airfoil and the baffle are made up of directionally solidified materials.

A further embodiment of any of the foregoing blades can further include that the airfoil and the baffle are made up of equiaxed materials.

A further embodiment of any of the foregoing blades can further include that the airfoil and the baffle are manufactured from a single material.

A method for forming a blade can include forming a platform and forming an airfoil on a layer-by-layer basis using additive manufacturing. The airfoil can include a first wall that extends radially from the platform to a blade tip and extends axially from a leading edge to a trailing edge, a second wall that extends radially from the platform to the blade tip and extends axially from the leading edge to the trailing edge where the first wall and the second wall are joined at the leading edge, and at least one rib that extends from the first wall to the second wall where the at least one rib and the first and second walls define a cavity. The method can also include forming a baffle within the cavity on a layer-by-layer basis using additive manufacturing where the baffle has walls that are separate and distinct from the at least one rib and the first and second walls.

The method of the preceding paragraph can optionally include, additionally and/or alternatively, any one or more of the following features, configurations and/or additional components:

A further embodiment of the foregoing method can further include that at least one impingement passage is formed in a baffle wall.

A further embodiment of any of the foregoing methods can further include that at least one film passage is formed in one of the first and second walls.

A further embodiment of any of the foregoing methods can further include that the at least one film passage is formed by additive manufacturing.

A further embodiment of any of the foregoing methods can further include that the at least one film passage is formed by drilling.

A further embodiment of any of the foregoing methods can further include that forming the first wall, forming the second wall, forming the at least one rib and forming the baffle are carried out using direct metal laser sintering.

A further embodiment of any of the foregoing methods can further include that forming the first wall, forming the second wall, forming the at least one rib and forming the baffle are carried out using electron beam melting.

A further embodiment of any of the foregoing methods can further include forming the airfoil on a layer-by-layer basis using additive manufacturing progresses from the platform to the blade tip.

Although the present invention has been described with reference to preferred embodiments, workers skilled in the art will recognize that changes may be made in form and detail without departing from the spirit and scope of the invention.

1. A blade comprising:
a platform;
a monolithic airfoil extending from the platform to a tip, the airfoil comprising:
a first wall extending from a leading edge to a trailing edge;
a second wall extending from the leading edge to the trailing edge and joined to the first wall at the leading edge; and
at least one rib extending from the first wall to the second wall, wherein the at least one rib and the first and second walls define a cavity; and
a baffle positioned within the cavity, the baffle having walls that are all separate and distinct from and not attached to the at least one rib and the first and second walls of the airfoil.

2. The blade of claim 1, further comprising:
at least one standoff rib positioned between the baffle walls and the first wall, wherein the standoff rib dampens vibration within the blade.

3. The blade of claim 2, wherein the at least one standoff rib is attached to only one of the first wall and the baffle.

4. The blade of claim 2, wherein the first wall comprises a first standoff rib that extends from the first wall towards the baffle, and wherein the second wall comprises a second standoff rib that extends from the second wall towards the baffle.

5. The blade of claim 4, wherein the baffle comprises a third standoff rib that extends from the baffle towards the first wall or the second wall.

6. The blade of claim 2, wherein the baffle comprises a standoff rib that extends from the baffle towards the first wall or the second wall.

7. The blade of claim 1, wherein the platform comprises:
At least one feed opening that allows cooling air to pass through the platform and flow between the baffle and at least one of the first and second walls.

8. The blade of claim 1, wherein at least one impingement passage is formed in a baffle wall.

9. The blade of claim 8, wherein at least one film passage is formed in one of the first and second walls.

10. The blade of claim 1, wherein the airfoil and the baffle comprise a directionally solidified material.

11. The blade of claim 1, wherein the airfoil and the baffle comprise an equiaxed material.

12. The blade of claim 1, wherein the airfoil and the baffle are manufactured from a single material.

13. A method for forming a blade, the method comprising:
forming a platform;
forming an airfoil on a layer-by-layer basis using additive manufacturing, wherein the airfoil comprises:
a first wall that extends radially from the platform to a blade tip and extends axially from a leading edge to a trailing edge;
a second wall that extends radially from the platform to the blade tip and extends axially from the leading edge to the trailing edge, wherein the first wall and the second wall are joined at the leading edge; and
at least one rib that extends from the first wall to the second wall, wherein the at least one rib and the first and second walls define a cavity; and
forming a baffle within the cavity on a layer-by-layer basis using additive manufacturing, wherein the baffle comprises walls that are separate and distinct from the at least one rib and the first and second walls.

14. The method of claim 13, wherein at least one impingement passage is formed in a baffle wall.

15. The method of claim 13, wherein at least one film passage is formed in one of the first and second walls.

16. The method of claim 15, wherein the at least one film passage is formed by additive manufacturing.

17. The method of claim 15, wherein the at least one film passage is formed by drilling.

18. The method of claim 13, wherein forming the first wall, forming the second wall, forming the at least one rib and forming the baffle are carried out using direct metal laser sintering.

19. The method of claim 13, wherein forming the first wall, forming the second wall, forming the at least one rib and forming the baffle are carried out using electron beam melting.

20. The method of claim 13, wherein forming the airfoil on a layer-by-layer basis using additive manufacturing progresses from the platform to the blade tip.
